(19) United States
(12) Patent Application Publication
(10) Pub. No.: US 2022/0170768 A1
(43) Pub. Date: Jun. 2, 2022

(54) Commissioning and Maintenance of Sensor and Measuring Transducer

(71) Applicant: Siemens Aktiengesellschaft, Muenchen (DE)

(72) Inventors: Markus HILSENDEGEN, Karlsruhe (DE); René PROBST, Karlsruhe (DE)

(21) Appl. No.: 17/534,839

(22) Filed: Nov. 24, 2021

(30) Foreign Application Priority Data
Nov. 28, 2020 (EP) 20210501

(51) Int. Cl. G01D 21/00; G06V 20/50; G06F 3/14; G06V 10/10; H04W 4/38

(52) U.S. Cl. CPC G01D 21/00; G06V 20/50; H04W 4/38; G06V 10/17; G06F 3/14

(57) ABSTRACT

A method for commissioning and maintenance of a sensor and a measuring transducer includes detecting an identity of the sensor and the measuring transducer, retrieving information from a data storage device with reference to the previously detected identities and the information relates to an operation of the sensor 1 and the measuring transducer, determining with reference to the previously retrieved information whether the sensor and the measuring transducer are configured for a cooperative operation, outputting the result of the determination via a graphic display.

### BACKGROUND OF THE INVENTION

### 1. Field of the Invention

The invention relates to a mobile data processing device, in particular a smartphone or a tablet, a computer program product and a method, for commissioning a sensor and an associated measuring transducer.

### 2. Description of the Related Art

A sensor and a measuring transducer, which are to cooperate, must be made known to one another and accordingly coordinated to one another, in other words configured. It is known to configure the sensor and the associated measuring transducer by hand or manually. Here, the associated sensor information (such, as a type and/or a specific circuit type) must initially be manually selected and afterward stored in the measuring transducer. Hitherto, the sensor information had to be determined laboriously by hand with reference to delivery papers, catalogues or other documentation. Hitherto, the sensor information was then transferred into a configuration tool and subsequently written into the measuring transducer.

In the past, additional parameters were written into the measuring transducer during the calibration. During recalibrations, the calibration data was often filed separately and, in general, was not used for a prediction of serviceable life. If in critical cases such an analysis was performed, it was only possible to perform this analysis with effort and formidable expertise.

In particular, during calibrations the quantity of data that is used can be particularly large in this case. As a consequence, this can lead to a large outlay of time. Moreover, there is the risk of an error that, where applicable, can lead to severe damage. A further disadvantage resides in the fact that during calibrations and maintenance in the life cycle it is often not possible to reliably document the operations and calibration data. A derivation of the sensor state owing to such an inadequate data situation is consequently difficult or even not possible at all.

DE 10 2013 013 299 A1 discloses a field device having a field device transceiver and a mobile operating device. Here, the operating device is configured so as to convey clearly identifying identification information to the field device transceiver and also to convey operating data via a radio connection to a superordinate data processing system. In this case, the superordinate data processing system is formed so as to operate the field device with reference to the identification information and the operating data.

### SUMMARY OF THE INVENTION

It is an object of the invention to provide a method and an associated mobile data processing device that render it possible to commission a sensor and an associated measuring transducer in a manner that is clearly more efficient than previously possible.

This and other objects and advantages are achieved in accordance with the invention by a method, a mobile data processing device, in particular a smartphone or a tablet, and a computer program product, where the method includes a) detecting an identity of a sensor and a measuring transducer; b) retrieving information from a data storage device with reference to the previously detected identities, where the information relates to an operation of the sensor and the measuring transducer; c) determining with reference to the previously retrieved information whether the sensor and the measuring transducer are configured for a cooperative operation; and d) outputting the result of the determination in method step c via a graphic display.

The measuring transducer is configured so as to detect a measuring variable, which is to be monitored, of the sensor (for example, temperature sensor, and/or pressure sensor) and to generate an electrical measurement signal that correlates with the prevailing value of the measuring variable. (Clear) information with regard to the determination of the identity of the sensor and the measuring transducer can be, for example, a serial number that the manufacturer of the sensor and the measuring transducer in each case have assigned (it need not necessarily be a single manufacturer for sensor and measuring transducer) in order to render a clear identification possible.

The data storage device can be located in the vicinity (for example, within the technical installation). The data storage device can, however, also be located in a remote location (for example with the manufacturer of the sensor and/or the measuring transducer). Information that relates to an operation of the sensor and the measuring transducer is stored in the data storage device. It is possible for this information to have been stored in the data storage device during the production of the sensor or the measuring transducer, where this information relates to specific operating data for the sensor or the measuring transducer. It is also possible in this context to speak of a digital twin of the sensor and the measuring transducer and the digital twin is stored in the data storage device.

With reference to the identities, which are conveyed to the data storage device, of the sensor and measuring transducer and the information that is retrieved from the data storage device, where the information relates to the operation of the sensor and the measuring transducer, it is thereupon determined whether the sensor and measuring transducer suit one another, i.e., are configured for a cooperative operation. The result of this examination is represented graphically so that, for example, a commissioning engineer of the sensor and the measuring transducer can obtain feedback in a simple manner in relation to an ability to cooperate/compatibility of the sensor and measuring transducer.

Preferrable, in the case of a positive result, the sensor and the measuring transducer are connected to one another to render possible a cooperative operation of the sensor and the measuring transducer. Here, the identity of the sensor and/or the measuring transducer case can be detected manually (for example, via reading an identification number of the sensor and/or the measuring transducer). It is preferred that the identity of the sensor and/or the measuring transducer is detected via an optical detection of the sensor and/or the measuring transducer, such as by identifying a QR code or by a method for optical character recognition (OCR).

Within the scope of a preferred embodiment of the invention, the previously explained method steps b and c are performed by a mobile data processing device, in particular a smartphone or a tablet. Here, the mobile data processing device establishes contact with the data storage device, retrieves the described information and performs the check of the ability of the sensor and measuring transducer to cooperate. Specifically in the case of exchanging the measuring transducer, the operating data of the sensor and the measuring transducer (inter alia operating hours, and/or operating states) are transmitted to the mobile data processing device in order to be able to transmit the operating data from the sensor and the measuring transducer back to the new measuring transducer after the exchange of the old measuring transducer for a new measuring transducer.

The determination of the identity of the sensor and the measuring transducer is also not necessarily but is advantageously performed via an optical detection of the sensor and/or measuring transducer by the mobile data processing device, in particular via a camera that is contained in the mobile data processing device.

It is particularly preferred that the method step d, in other words the graphic output of the result of the previously performed check for compatibility, is likewise performed by the mobile data processing device. Alternatively or additionally, the output can however also, be assumed by a separate display device.

In the case of a preferred embodiment of the invention, after the connection of the sensor and the measuring transducer the following are additionally performed:
e) build a data connection from the mobile data processing device to the sensor and/or the measuring transducer;
f) transmit data in relation to a calibration of the sensor and/or the measuring transducer from the sensor and/or the measuring transducer to the mobile data processing device;
g) transmit the data, which is received by the sensor and/or the measuring transducer, in relation to a calibration of the sensor and/or the measuring transducer into the data storage device;
h) determine based on the transmitted data in relation to a calibration of the sensor and/or the measuring transducer whether the sensor and the measuring transducer are furthermore configured for a cooperative operation or whether new calibration data must be transmitted from the data storage device;
i) transmit, where applicable, the new calibration data from the data storage device to the sensor and/or the measuring transducer by the mobile data processing device;
j) graphically output, by the mobile data processing device an indication that the sensor and the measuring transducer can furthermore be connected to one another.

It is possible owing to this embodiment to perform maintenance and where applicable a required recalibration of the sensor and the measuring transducer in an efficient manner.

It is preferred that after the determination in accordance with method step d of the previously explained embodiment of the method in accordance with the invention, a calibration rhythm is determined for the sensor and/or the measuring transducer with reference to the transmitted data in relation to a calibration of the sensor and/or the measuring transducer and with reference to calibration data, which is already previously stored on the data storage device, in relation to a calibration of the sensor and/or the measuring transducer. Here, methods of self-learning systems can be used to further refine a prognosis via necessary maintenance/recalibrations of the sensor and measuring transducer.

In this case, it is also possible to incorporate environmental parameters that have previously been determined by the sensor and/or the measuring transducer in the case of the determination of the calibration rhythm for the sensor and/or the measuring transducer.

It is also an object of the invention moreover to provide a mobile data processing device, in particular a smartphone or a tablet, which comprises a processor and memory, where the processor is configured so as to implement the method in accordance with disclosed embodiments.

It is a further object of the invention to provide a computer program product comprising program commands and in the case of the execution of the computer program by a processor of a computer, the program commands trigger this computer to implement the method in accordance with disclosed embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described characteristics, features and advantages of this invention and also the manner in which these are achieved become clearer and more explicitly understandable in conjunction with the following description of the exemplary embodiment that is further explained in conjunction with the drawings, in which:

FIG. 1 is a schematic block diagram of a sensor, a measuring transducer, a mobile data processing device and a data storage device in accordance with the invention; and

FIG. 2 is a flowchart of the method in accordance with the invention.

### DETAILED DESCRIPTION OF THE EXEMPLARY EMBODIMENTS

A sensor 1, a measuring transducer 2, a mobile data processing device 3 and a data storage device 4 are illustrated in the FIG. 1. The sensor 1 has a QR code 5 as identification information. The measuring transducer 2 also has a QR code 6 as identification information. The mobile data processing device 3 has a camera 7 for identifying optical information.

The sequence of the method in accordance with the invention is explained below in an exemplary manner. The sensor 1 and the measuring transducer 2 are to be connected to one another for use in a technical installation. For this purpose, a commissioning engineer of the technical installation in a first method step I detects the QR codes 5, 6 of the sensor 1 and the measuring transducer 2 via the mobile data processing device 3 via the camera 7. In a second method step II, the mobile data processing device 3 subsequently establishes contact with the data storage device 4 and conveys the previously detected identities of the sensor 1 and the measuring transducer 2 to the data storage device 4.

In a third method step III, with reference to the conveyed identities, the data storage device 4 (more precisely: an authority that controls the data storage device) provides information to the mobile data processing device 3, where the information relates to an operation of the sensor 1 and the measuring transducer 2. In a fourth method step IV, the mobile data processing device 3, based on the previously retrieved information, determines whether the sensor 1 and the measuring transducer 2 are configured for a cooperative operation. The result of this check is represented graphically via a graphic display 8 of the mobile data processing device 3 and can be understood in particular by the commissioning engineer. In the case of a positive check result, the sensor 1 and the measuring transducer 2 can be combined with one another (paired).

After connecting the sensor 1 and the measuring transducer 2, the following steps are additionally performed:

Initially, a data connection is built from the mobile data processing device 3 to the sensor 1 and/or the measuring transducer 2. Data in relation to a calibration of the sensor 1 and/or the measuring transducer 2 is thereupon transmitted from the sensor 1 and/or the measuring transducer 2 to the mobile data processing device 3. The data, which is previously received by the sensor 1 and/or the measuring transducer 2, in relation to a calibration of the sensor 1 and/or the measuring transducer 2, is transmitted into the data storage device 4. Based on the transmitted data in relation to a calibration of the sensor 1 and/or the measuring transducer 2, it is then determined whether the sensor 1 and the measuring transducer 2 are furthermore configured for a cooperative operation or whether it is necessary to transmit new calibration data from the data storage device 4.

In this case, a calibration rhythm is additionally determined for the sensor 1 and/or the measuring transducer 2 with reference to the transmitted data in relation to a calibration of the sensor 1 and/or to the measuring transducer 2 and with reference to calibration data, which is already previously stored on the data storage device 4, in relation to a calibration of the sensor 1 and/or the measuring transducer 2. Here, it is also possible to incorporate environmental parameters that have previously been determined by the sensor 1 and/or the measuring transducer 2 in the case of the determination of the calibration rhythm for the sensor 1 and/or the measuring transducer 2.

Where applicable, the new calibration data is finally transmitted by the mobile data processing device 3 from the data storage device 4 to the sensor 1 and/or to the measuring transducer 2. Finally, a graphic output by the display 8 of the mobile data processing device 3 then occur such that the sensor 1 and the measuring transducer 2 can furthermore be connected to one another.

FIG. 2 is a flowchart of the method in accordance with the invention. The method comprises a) detecting an identity of a sensor 1 and a measuring transducer 2, as indicated in step 210.

Next, b) information from a data storage device 4 with reference to previously detected identities is retrieved, as indicated in step 220. In accordance with the invention, the information relates to an operation of the sensor 1 and the measuring transducer 2.

Next, c) whether the sensor 1 and the measuring transducer 2 are configured for a cooperative operation is determined with reference to the previously retrieved information, as indicated in step 230.

Next, d) a result of the determination is output via a graphic display 8, as indicated in step 240.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method, comprising:
a) detecting an identity of a sensor and a measuring transducer;
b) retrieving information from a data storage device with reference to previously detected identities, said information relating to an operation of the sensor 1 and the measuring transducer;
c) determining, with reference to the previously retrieved information, whether the sensor and the measuring transducer are configured for a cooperative operation;
d) outputting a result of said determination via a graphic display.

2. The method as claimed in claim 1, further comprising:
connecting the sensor and the measuring transducer to one another in order to render possible a cooperative operation of the sensor and the measuring transducer upon determining the sensor and the measuring transducer are configured for cooperative operation.

3. The method as claimed in claim 1, wherein at least one of the identities of the sensor and the measuring transducer 2 is detected via an optical detection of at least one of the sensor and the measuring transducer.

4. The method as claimed in claim 2, wherein at least one of the identities of the sensor and the measuring transducer is detected via an optical detection of at least one of the sensor and the measuring transducer.

5. The method as claimed in claim 1, wherein said retrieving and determining are performed by a mobile data processing device.

6. The method as claimed in claim 2, wherein said retrieving and determining are performed by a mobile data processing device.

7. The method as claimed in claim 5, wherein the processing device comprises a smartphone or a tablet.

8. The method as claimed in claim 6, wherein the processing device comprises a smartphone or a tablet.

9. The method as claimed in claim 3, wherein said detecting, retrieving and determining are performed by a mobile data processing device.

10. The method as claimed in claim 9, wherein the processing device comprises a smartphone or a tablet.

11. The method as claimed in claim 11, wherein said outputting is performed by a mobile data processing device.

12. The method as claimed in step 11, wherein the processing device comprises a smartphone or a tablet.

13. The method as claimed in claim 5, further comprising:
connecting the sensor and the measuring transducer to one another in order to render possible a cooperative operation of the sensor and the measuring transducer upon determining the sensor and the measuring transducer are configured for cooperative operation;
wherein, subsequent to connection of the sensor and the measuring transducer, the method further comprises:
e) building a data connection from the mobile data processing device to at least one of the sensor and the measuring transducer;
f) transmitting data in relation to a calibration of at least one of the sensor and the measuring transducer from at least one of the sensor and the measuring transducer to the mobile data processing device;
g) transmitting the data, which is received by at least one of the sensor and the measuring transducer, in relation to the calibration of at least one of the sensor and the measuring transducer into the data storage device;
h) determining, based on the transmitted data in relation to the calibration of at least one of the sensor and the measuring transducer whether the sensor 1 and the measuring transducer are furthermore configured for one of the cooperative operation and whether new calibration data must be transmitted from the data storage device;
i) transmitting, when the new calibration data must be transmitted from the data storage device, the new calibration data from the data storage device to at least one of the sensor and the measuring transducer by the mobile data processing device;
j) graphically outputting by the mobile data processing device an indication that the sensor 1 and the measuring transducer can furthermore be connected to one another.

14. The method as claimed in claim 9, further comprising:
connecting the sensor and the measuring transducer to one another in order to render possible a cooperative operation of the sensor and the measuring transducer 2 upon determining the sensor and the measuring transducer are configured for cooperative operation;
wherein subsequent to connection of the sensor and the measuring transducer, the method further comprises:
e) building a data connection from the mobile data processing device to at least one of the sensor and the measuring transducer;
f) transmitting data in relation to a calibration of at least one of the sensor and the measuring transducer from at least one of the sensor and the measuring transducer to the mobile data processing device;
g) transmitting the data, which is received by at least one of the sensor and the measuring transducer, in relation to the calibration of at least one of the sensor and the measuring transducer into the data storage device;
h) determining, based on the transmitted data in relation to the calibration of at least one of the sensor and the measuring transducer whether the sensor and the measuring transducer are furthermore configured for one of the cooperative operation and whether new calibration data must be transmitted from the data storage device;
i) transmitting, when the new calibration data must be transmitted from the data storage device, the new calibration data from the data storage device to at least one of the sensor and the measuring transducer by the mobile data processing device;
j) graphically outputting by the mobile data processing device an indication that the sensor 1 and the measuring transducer can furthermore be connected to one another.

15. The method as claimed in claim 11, further comprising:
connecting the sensor and the measuring transducer to one another in order to render possible a cooperative operation of the sensor and the measuring transducer upon determining the sensor and the measuring transducer are configured for cooperative operation;
wherein subsequent to connection of the sensor and the measuring transducer, the method further comprises:
e) building a data connection from the mobile data processing device to at least one of the sensor and the measuring transducer;
f) transmitting data in relation to a calibration of at least one of the sensor and the measuring transducer from at least one of the sensor and the measuring transducer to the mobile data processing device;
g) transmitting the data, which is received by at least one of the sensor and the measuring transducer, in relation to the calibration of at least one of the sensor and the measuring transducer into the data storage device;
h) determining, based on the transmitted data in relation to the calibration of at least one of the sensor and the measuring transducer whether the sensor and the measuring transducer are furthermore configured for one of the cooperative operation and whether new calibration data must be transmitted from the data storage device;
i) transmitting, when the new calibration data must be transmitted from the data storage device, the new calibration data from the data storage device to at least one of the sensor and the measuring transducer by the mobile data processing device;
j) graphically outputting by the mobile data processing device an indication that the sensor and the measuring transducer can furthermore be connected to one another.

16. The method as claimed in claim 13, wherein after said determining in accordance with step h) a calibration rhythm is determined for at least one of the sensor and the measuring transducer with reference to the transmitted data in relation to the calibration of at least one of the sensor and the measuring transducer and with reference to calibration data, which is already previously stored on the data storage device, in relation to the calibration of at least one of the sensor and the measuring transducer.

17. The method as claimed in claim 16, wherein environmental parameters which have previously been determined by at least one of the sensor and the measuring transducer are also incorporated in cases of the determination of the calibration rhythm for at least one of the sensor and the measuring transducer.

18. A mobile data processing device, comprising:
a processor; and
memory;
wherein the processor is configured to:
a) detect an identity of a sensor and a measuring transducer;
b) retrieve information from a data storage device with reference to previously detected identities, said information relating to an operation of the sensor and the measuring transducer;
c) determine, with reference to the previously retrieved information, whether the sensor and the measuring transducer are configured for a cooperative operation;
d) output a result of said determination via a graphic display.

19. The device as claimed in claim 18, wherein the mobile data processing device comprises a smartphone or a tablet.

20. A non-transitory computer-readable program product encoded with program commands which, when executed by a processor of a computer, trigger said computer to commission a sensor and an associated measuring transducer, the program commands comprising:
a) program code for detecting an identity of a sensor and a measuring transducer;
b) program code for retrieving information from a data storage device with reference to previously detected identities, said information relating to an operation of the sensor and the measuring transducer;
c) program code for determining, with reference to the previously retrieved information, whether the sensor and the measuring transducer are configured for a cooperative operation; and
d) program code for outputting a result of said determination via a graphic display.
